(19) United States
(12) Patent Application Publication
(10) Pub. No.: US 2012/0229897 A1
(43) Pub. Date: Sep. 13, 2012

(54) Achromatic Phase Retarder with Anisotropic Layered Structure

(75) Inventor: Yi-Jun Jen, Keelung City (TW)

(73) Assignee: NATIONAL TAIPEI UNIVERSITY OF TECHNOLOGY, Taipei (TW)

(21) Appl. No.: 13/195,103

(22) Filed: Aug. 1, 2011

(30) Foreign Application Priority Data
Mar. 10, 2011 (TW) 100108002

(51) Int. Cl. G02B 5/30; B32B 37/02

(52) U.S. Cl. 359/489.07; 156/60

(57) ABSTRACT

A phase retarder including a transparent substrate; and at least a symmetrical or pseudo symmetrical film stack stacked on the transparent substrate, the symmetrical or pseudo symmetrical film stack having odd numbers of thin film, the odd numbers of thin film having an intermediate thin film located at the center of the symmetrical or pseudo symmetrical film stack and at least one thin film located respectively on two sides of the intermediate thin film, and, with respect to the central thin film, properties of the thin films located respectively on two sides of the intermediate thin film are symmetrical or pseudo-symmetrical, there is at least one anisotropic thin film in the symmetrical or pseudo symmetrical film stack.

### BACKGROUND OF THE INVENTION

1. Field of the Invention

This present invention relates to a phase retarder which is capable of providing a substantial constant phase retardation effect over a wide range of frequency spectrum. In particular, the phase retarder is an achromatic phase retarder implementing anisotropic films.

2. Description of the Prior Art

The wave plate, also named as phase retarder, is typically made of birefringent anisotropic optical material. While the light beam proceeds within the wave plate of anisotropic material, the electrical field components of light beam respectively corresponds to the two components of eigen-polarization states in the material. This makes the light beam experiencing two different refractive indices of the material, namely the principal refractive index N1 and N2. Then, the light beam is splitted into two light beams of different refractive angles and wave speeds. If the incident light beam enters vertically the wave plate, the respective refractive angles are zero both to the two splitted light beams. However, since the oscillating wave speeds corresponding to two components of eigen-electrical field are different from each other, after passing through the wave plate, phase difference is produced between the two components of linearly polarized light beam. To wave plate of ½ or ¼ wave delay, two components that are vertical to each other will experience a phase difference of π or π/2. For the ¼ (quarter) wave plate, it transforms the linearly polarized state light beam into the circularly polarized state light beam.

The above-mentioned phase difference might be represented as 2π(N1−N2)d/λ, wherein d is wave plate thickness, λ is wavelength of incident light beam. From this, it can be observed the phase difference is function of wavelength. To achieve the effect of irrelevance of wavelength to the phase difference for a desired range of wavelength, it must be satisfied that (N1−N2) is linearly proportional to wavelength, that is (N1−N2)=a λ, a is a constant. It is quite difficult to discover in the nature a material having principal refringence difference proportional to wavelength. However, in 2009, one scholar discovered that eyes of mantis shrimps has a wave plate exhibiting delay of ¼ wave constantly (homogeneously) over a visible spectrum. A well known periodical “Nature Photonics” has reported this discovery under the headline of “perfect wave plate”.

Recently some researches proposed the structure of subwavelength grating to make a wave plate which is capable of reducing phase difference variation caused by the variable of wavelength. However it has been found to be difficult to produce and no actual final products are really successfully made.

In the context of thin film technologies, the symmetrical film stack is noted as being with respect to the property or thickness of each film in the stack, e.g. the film stack such as ABA, ABCBA or ABCDCBA are symmetrical film stack. The optical property of symmetrical film stack might be equivalently viewed as one having refractive index N and phase thickness φ, with physical meaning of phase thickness φ being interpreted as the amount of wavelength proceeded by the entering light beam, or variation of light phase. The equivalent refractive index N and phase thickness φ of symmetrical film stack are both functions of wavelength λ, each refractive index of constituting films therein, incidence angle, thickness. As the symmetrical film stack is repeated m times, the equivalent film refractive index is still N, and the phase thickness φwill become m times of single one film (i.e. m φ).

### SUMMARY OF THE INVENTION

In accordance with one aspect of the invention, a phase retarder is capable of providing a substantial constant phase retardation effect over a wide range of frequency spectrum.

The aforesaid objective of the invention is achieved by combining properties of the pseudo symmetrical film stack and the anisotropic film.

By combining the anisotropic material and the pseudo symmetrical film stack, the present invention devises a system of multiple pseudo-symmetrical films. The pseudo-symmetrical film stack includes at least an anisotropic film, for example, an anisotropic film and an isotropic film. Corresponding to light beams of two different polarization states, there are two overall refractive indices Na, Nb and two m φₐ, m φ_{b} (phase delay). Each of four variables is function of wavelength, refractive index of constituting films, incidence angle of light beam and thickness of each constituting films. Through the optimization combination of the anisotropic material and the pseudo symmetrical film stack, the phase difference (m φₐ−m φ_{b}) can be observed as being almost constant over a wide rang of frequency spectrum.

Optionally, at least one matching layer (film) is included between the film stack and the incident medium or between the film stack and the substrate, and that helps to make a homogeneous transmissivity (or transmission) over a wide wavelength range of (e.g., 400-700 nm). Due to this optional arrangement in this wave plate, the polarized lights of two polarization states (a, b) have the substantial identical light beam intensity. Another approach is to fine tune the respective thickness within symmetrical film stack for achieving the polarized lights of two polarization states (a, b) having the substantial identical light beam intensity.

In accordance with one embodiment, an achromatic phase retarder having an anisotropic film, comprising: a transparent substrate; and at least a symmetrical or a pseudo-symmetrical film stack stacked over the transparent substrate. The symmetrical or a pseudo symmetrical film stack including odd number of film(s), the odd number of film(s) having an intermediary film disposed at a midst location, and with respect to the intermediary film, properties of films on the two sides thereof are symmetrical or pseudo-symmetrical to each other, wherein the odd number of films including at least an anisotropic film.

In accordance with the embodiment of method, a method for producing an achromatic phase retarder having an anisotropic film comprising: providing a transparent substrate; and stacking at least a symmetrical or a pseudo symmetrical film stack over the transparent substrate. The symmetrical or the pseudo symmetrical film stack including odd number of film(s), the odd number of film(s) having an intermediary film disposed at a midst location, and with respect to the intermediary film, properties of films on the two sides thereof are symmetrical or pseudo-symmetrical to each other, wherein the odd number of films including at least an anisotropic film.

More details of the respective embodiments can be found in the respective iterations in the dependent claims hereinafter recited.

All aspects of the present invention will no doubt become apparent to those of ordinary skills in the art after reading the following detailed description of the preferred embodiment, which is illustrated in the following figures and drawings.

### BRIEF DESCRIPTION OF THE APPENDED DRAWINGS

FIG. 1 discloses a laminated (layered) achromatic phase retarder 10 according to first embodiment of this invention;

FIG. 2 discloses an embodiment, ABA, for the (pseudo) symmetrical film stack 103 in FIG. 1;

FIG. 3 discloses another embodiment, A′B′C′DCAB, for the (pseudo) symmetrical film stack 103 in FIG. 1;

FIG. 4 discloses another embodiment for the laminated (layered) achromatic phase retarder of this invention;

FIG. 5 discloses still another embodiment for the laminated (layered) achromatic phase retarder of this invention;

FIG. 6 discloses the variation of phase delay amount over a wavelength range as laminated (layered) achromatic phase retarder of this invention is employed;

FIG. 7 discloses the polarization states in terms of Stokes parameters as light of various wavelengths passing through the laminated (layered) achromatic phase retarder of this invention.

### DETAILED DESCRIPTION OF THE INVENTION

Some preferred embodiments and practical applications of this present invention would be explained in the following paragraph, describing the characteristics, spirit and advantages of the invention.

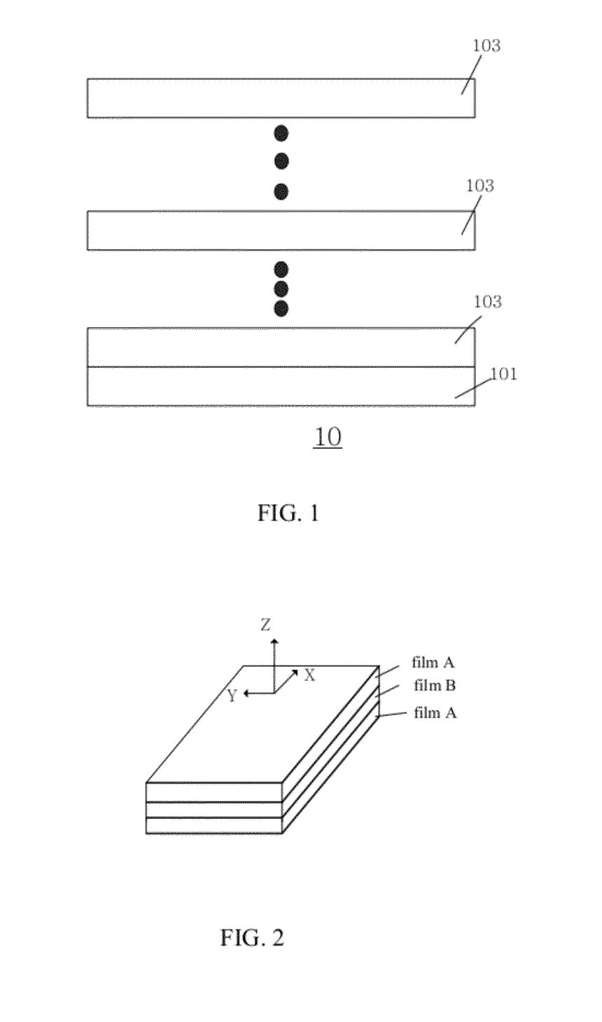

As shown in FIG. 1, the phase retarder 10 having an anisotropic film of the invention includes a transparent substrate 101 and at least a symmetrical or pseudo symmetrical film stack 103. The (pseudo) symmetrical film stack is stacked over the transparent substrate 101, the (pseudo) symmetrical film stack 103 includes odd number of film(s), and the odd number of film(s) include an intermediary film disposed at a midst location, and with respect to the intermediary film, the properties of films at two sides are identical or resembling (similar) to each other. The odd number of film(s) include at least an anisotropic film.

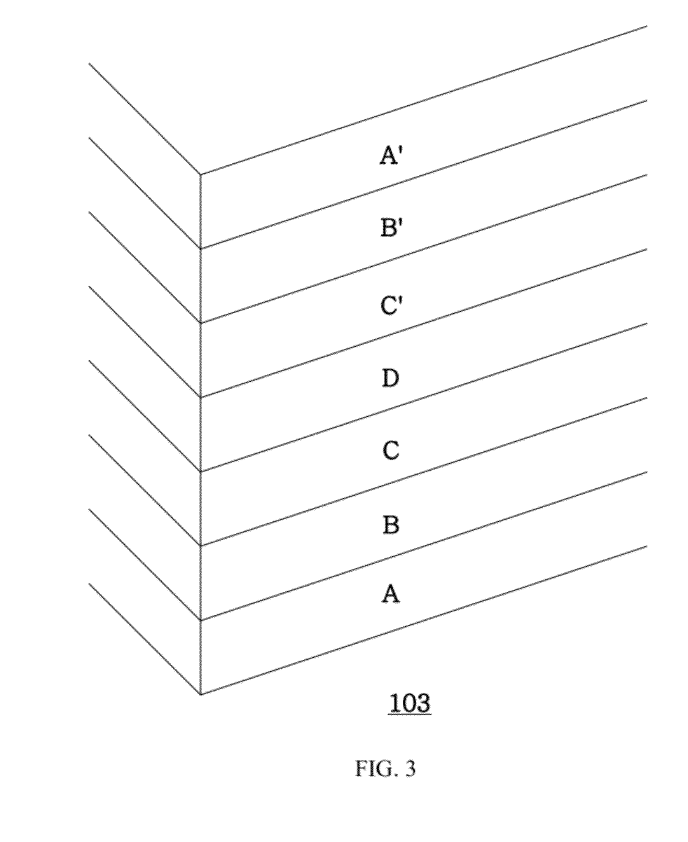

One embodiment of pseudo-symmetrical film stack 103 is shown FIG. 2 for explaining the meaning of pseudo-symmetry. The disclosed stack 103 includes film A′/film B/film A. About the film properties, properties of A′≈those of A (similar, akin), or properties of A′=those of A (substantially identical). The corresponding thickness d, d′ might be also similar, or even might be substantially identical. The film A or A′ is an anisotropic film and the film B is an isotropic film. Or the film A or A′ is an isotropic film and the film B is an anisotropic film. As the properties are akin, the relationship is named as pseudo-symmetry in the entire specification.

Another embodiment of pseudo-symmetrical film stack 103 is shown FIG. 3 in which the pseudo-symmetrical film stack includes film A′/film B′/film C′/film D/film C/film B/film A, wherein the film D is the intermediary film. The properties of A′≈those of A (akin) or the properties of A′=those of A, the properties of B′≈those of B (resembling) or the properties of B′=those of B, the properties of C′ ≈those of C (similar) or the properties of C′=those of C. As the properties are akin, it is called pseudo-symmetry.

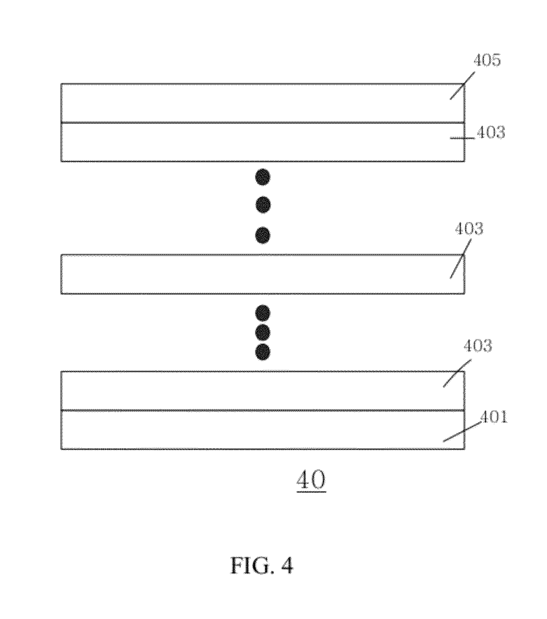

Another embodiment of the phase retarder 40 of the present invention is shown in FIG. 4. Other than transparent substrate 401 and at least a pseudo-symmetrical film stack 403, the phase retarder 40 further includes at least a matching layer 405 deposited over the pseudo-symmetrical film stack 403. The matching layer 405 is selected from an isotropic film or an anisotropic film and is provided for inputting the light beam first. And then the light beam enters the laminated (layered) phase retarder 40. The matching layer 405 functions to render the transmitted light beam of different polarization states to have substantially identical or similar transmission.

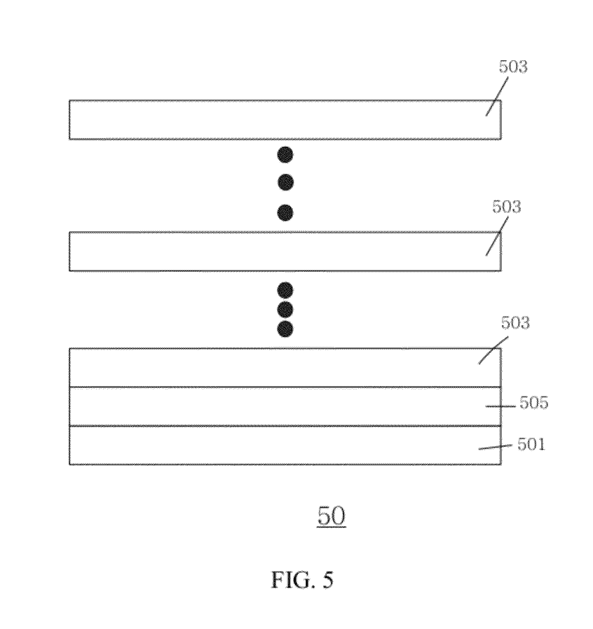

Another embodiment of the phase retarder 50 of the present invention is shown in FIG. 5. Other than transparent substrate 501 and at least a pseudo-symmetrical film stack 503, the phase retarder 50 further includes at least a matching layer 505 deposited between the pseudo-symmetrical film stack 503 and the transparent substrate 501. The matching layer 505 is selected from an isotropic film or an anisotropic film. The matching layer 505 functions to render the transmitted light beam of different polarization states to have substantially identical or similar transmission.

### Example

As shown in FIG. 1, the wave plate having multiple anisotropic films might includes sevenfold of the symmetrical film stack A′/B/A (as shown in FIG. 2) which totals 21 films altogether, wherein the film plane is x-y plane and the normal of plane is z direction indicated in FIG. 2. The anisotropic film A or A′ may be deposited by utilizing interlacely the inclined deposition method in which material of Ta₂O₅ is employed. The deposition plane is x-z plane, and the deposition processes are interlacely repeated in which each 5 nm thin-film is deposited by one cycle at which positive 75 deposition angles, with respect to the z direction, is specified followed by another cycle at which negative 75 deposition angles is specified until a total thickness of 50 nm anisotropic film is obtained. Taking the example of incident light beam impinging vertically on the anisotropic film A, the electric field of electric-magnetic wave experiences refractive index of 1.443(N_{Ax}) as it oscillates along x direction, and the electric field of electric-magnetic wave experiences refractive index of 1.568(N_{Ay}) as it oscillates along y direction.

The anisotropic film B may be deposited by utilizing interlacely the inclined deposition method in which material of Ta₂O₅ is employed. The deposition plane is y-z plane, and the deposition processes are interlacely repeated in which one cycle at which positive 68 deposition angles, with respect to the z direction, is specified followed by another cycle at which negative 68 deposition angles is specified until a total thickness of 143 nm anisotropic film B is obtained. Taking the example of incident light beam impinging vertically on the anisotropic film B, the electric field of electric-magnetic wave experiences refractive index of 1.684(N_{Bx}) as it oscillates along x direction, and the electric field of electric-magnetic wave experiences refractive index of 1.638(N_{By}) as it oscillates along y direction.

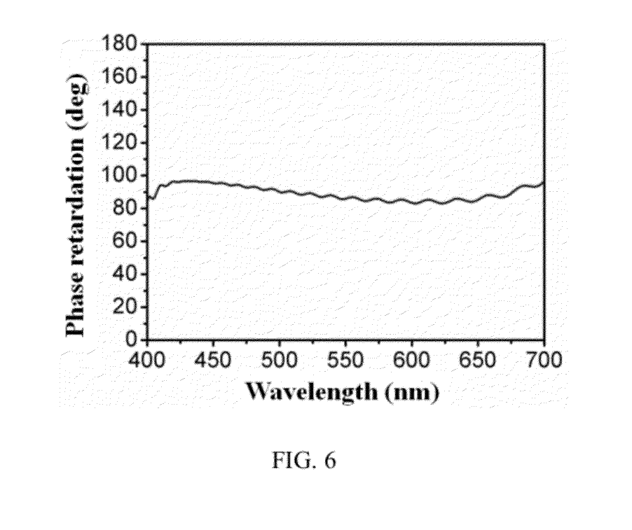

In the example of FIG. 4, the substrate 401 is the glass substrate of product code of BK7, and a matching layer 405 of SiO2 isotropic film, which has refractive index of 1.457 and thickness of 34 nm, is further coated between the symmetrical film stack 403 and medium (air). As seven (pseudo) symmetrical film stacks are utilized, the entire laminated (layered) wave plate has configuration of air/matching layer 405/(ABA)(ABA)(ABA)(ABA)(ABA)(ABA)(ABA)/BK7. The variation of phase delay amount (angle) with respect to the wavelength in the visible light range has been found and depicted in FIG. 6. As indicated in FIG. 6, the objective of the invention is achieved by wave plate provided which has substantial homogeneous phase delay effect within the range of 400 nm to 700 nm. The resulting phase delay angle (amount) has average value of 91.37 degrees and the variation amount is only ±7.89 degrees for the entire range of 400 nm to 700 nm.

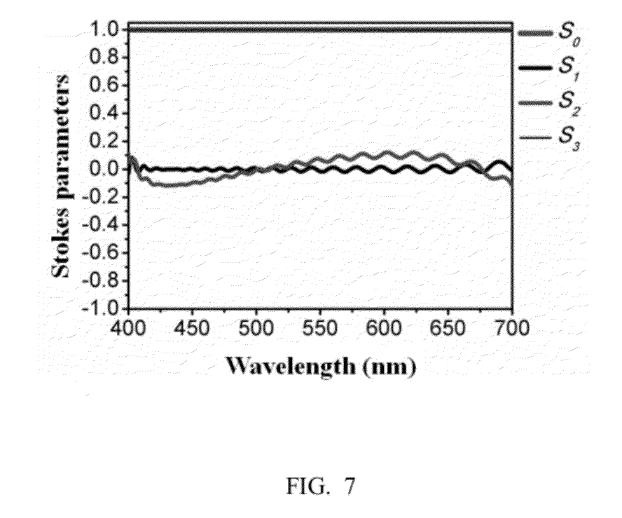

For the range of visible-light range of 400 nm to 700 nm, the Stokes Parameters (s0, s1, s2, s3), which describes the corresponding transformed polarized light after an incident linearizedly polarized light beam passes through the wave plate of present invention, with respect to different wavelength is shown in FIG. 7. It is well known that one set of (s0, s1, s2, s3) value defines an elliptically polarized light, and different set of (s0, s1, s2, s3) value corresponds to different elliptically polarized light. From FIG. 7, it is observed that the values of (s0, s1, s2, s3) for different wavelengths are substantially identical. Therefore, it is concluded that the wave plate of invention indeed can transform to substantially identical elliptically polarized light regardless of the wavelength within the visible light range.

The method for making the phase retarder of the invention is recited in the followings.

Implicitly described in FIG. 1, FIG. 2, FIG. 3, FIG. 4 and FIG. 5, the method of making the phase retarder of the present invention includes: providing a transparent substrate 101; and stacking at least a symmetrical or pseudo-symmetrical film stack 103 over the transparent substrate 101. The pseudo-symmetrical film stack 103 includes odd number of thin films (for instance, A′/B/A), and the odd number of films includes an intermediary film B disposed at a midst location, and with respect to the intermediary film B, the properties of films at two sides (for example A′, A) are pseudo symmetrical to each other, and wherein odd number of films include at least an anisotropic film.

According to one embodiment, the method further includes stacking at least a matching layer 405 over the at least a symmetrical or pseudo-symmetrical film stack, and the matching layer 405 is selected from an isotropic film or an anisotropic film. The light beam first impinges the matching layer 405 and then enters the laminated (layered) phase retarder. The matching layer 405 functions to render the transmitted light beam of different polarization states to have substantially identical or similar transmissivity (or transmission).

According to another embodiment, the method further includes stacking at least a matching layer 505 between the at least a symmetrical or pseudo-symmetrical film stack and transparent substrate, and the matching layer 505 is selected from an isotropic film or an anisotropic film. The light beam impinges the laminated (layered) phase retarder first and then the matching layer 505. The matching layer 505 functions to render the transmitted light beam of different polarization states to have substantially identical or similar transmissivity (or transmission).

As a polarizing film is deposited over the laminated (layered) phase retarder, a polarizing apparatus is then formed. Under this circumstance, the polarizing apparatus includes the laminated (layered) phase retarder and the polarizing film, and the polarizing film is disposed ahead of the laminated (layered) phase retarder along the light path direction.

With the example and explanations above, the features and spirits of the invention will be hopefully well described. It is understood that the invention is not only limited to those described embodiments and it is highly possible for persons skilled in the arts, without departing the spirit of the invention, might make various alteration, modification or equivalent transformation.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An achromatic phase retarder having an anisotropic film, comprising:
a transparent substrate; and
at least a symmetrical or a pseudo-symmetrical film stack stacked over the transparent substrate, the symmetrical or a pseudo symmetrical film stack including odd number of film(s), the odd number of film(s) having an intermediary film disposed at a midst location, and with respect to the intermediary film, properties of films on the two sides thereof are symmetrical or pseudo-symmetrical to each other, wherein the odd number of films including at least an anisotropic film.

2. The phase retarder of claim 1, further comprising at least a matching layer on the symmetrical or pseudo symmetrical film stack, the matching layer is selected from an isotropic film or an anisotropic film, the matching layer inputting a light beam and providing substantially identical or similar transmission over a wide range of light beam of different polarization states, the outputted light beam from the matching layer then enters the phase retarder.

3. The phase retarder of claim 1, further comprising at least a matching layer disposed between the symmetrical or a pseudo symmetrical film stack and the transparent substrate, the matching layer is selected from an isotropic film or an anisotropic film, the matching layer inputting a light beam and providing substantially identical or similar transmission over a wide range of light beam of different polarization states, the outputted light beam from the matching layer then enters the phase retarder.

4. The phase retarder of claim 1, wherein the symmetrical or the pseudo symmetrical film stack includes film A′/film B/film A, film B is the intermediary film, property of A′≈property of A, or property of A′=property of A.

5. The phase retarder of claim 4, wherein thickness of A′≈thickness of A, or thickness of A′=thickness of A.

6. The phase retarder of claim 4, wherein thickness of A′=thickness of A, and film A or film A′ is an anisotropic film.

7. The phase retarder of claim 1, wherein symmetrical or a pseudo symmetrical film stack includes film A′/film B′/film C′/film D/film C/film B/film A, film D is the intermediary film, property of A′≈property of A or property of A′=property of A, property of B′≈property of B or property of B′=property of B, property of C′≈property of C or property of C′=property of C.

8. A method for producing an achromatic phase retarder having an anisotropic film comprising:
providing a transparent substrate; and
stacking at least a symmetrical or a pseudo symmetrical film stack over the transparent substrate, the symmetrical or the pseudo symmetrical film stack including odd number of film(s), the odd number of film(s) having an intermediary film disposed at a midst location, and with respect to the intermediary film, properties of films on the two sides thereof are symmetrical or pseudo-symmetrical to each other, wherein the odd number of films including at least an anisotropic film.

9. The method of claim 8, further comprising:
stacking at least a matching layer on the symmetrical or the pseudo symmetrical film stack, the matching layer is selected from an isotropic film or an anisotropic film, the matching layer inputting a light beam and providing substantially identical or similar transmission over a wide range of light beam of different polarization states, the outputted light beam from the matching layer then enters the phase retarder.

10. The method of claim 9, further comprising:
stacking at least a matching layer between the symmetrical or the pseudo symmetrical film stack and the transparent substrate, the matching layer is selected from an isotropic film or an anisotropic film, the matching layer inputting a light beam and providing substantially identical or similar transmission over a wide range of light beam of different polarization states, the outputted light beam from the matching layer then enters the phase retarder.

11. An achromatic phase retarder having an anisotropic film, comprising:
a transparent substrate;
at least a symmetrical or a pseudo-symmetrical film stack stacked over the transparent substrate, the symmetrical or a pseudo symmetrical film stack including odd number of film(s), the odd number of film(s) having an intermediary film disposed at a midst location, and with respect to the intermediary film, property of films on the two sides thereof are symmetrical or pseudo-symmetrical to each other, wherein the odd number of films including at least an anisotropic film; and
at least a matching layer on the symmetrical or pseudo symmetrical film stack, the matching layer is selected from an isotropic film or an anisotropic film, the matching layer inputting a light beam and providing substantially identical or similar transmission over a wide range of light beam of different polarization states, the outputted light beam from the matching layer then enters the phase retarder.
